(19) United States
(12) Patent Application Publication
(10) Pub. No.: US 2017/0115853 A1
(43) Pub. Date: Apr. 27, 2017

(54) Determining Image Captions

(71) Applicant: Google Inc., Mountain View, CA (US)

(72) Inventors: Kevin Allekotte, Tokyo (JP); David Robert Gordon, Tokyo (JP)

(21) Appl. No.: 14/918,937

(22) Filed: Oct. 21, 2015

(51) Int. Cl. G06F 3/0484; G06F 3/0482; G06K 9/34; G06T 7/00; G06F 17/30; G06K 9/00

(52) U.S. Cl. CPC G06F 3/04842; G06F 17/30247; G06K 9/00456; G06K 9/344; G06T 7/0081; G06F 3/0482; G06K 2209/01; G06T 2207/10016

(57) ABSTRACT

Systems and methods of determining image captions are provided. In particular, metadata and image recognition data associated with an image can be obtained. The metadata and image recognition data can be used to generate one or more image tags associated with the image. One or more caption templates associated with the image can further be determined. Upon a selection of one or more of the image tags, an image caption can be generated using a caption template based at least in part on the user selection. The generated caption can be a sentence or phrase providing semantic and/or contextual information associated with the image.

### FIELD

The present disclosure relates generally to determining image captions and more particularly to automatically determining image captions based at least in part on metadata and image recognition data associated with an image.

### BACKGROUND

Images submitted on various online platforms or services may be accompanied by a textual caption. Such captions may be inputted by a user, and may include semantic and/or contextual information associated with the image. For instance, a caption may provide a description of an activity being performed at a location, as depicted in the image. In addition, image captions may provide information that is not visible or representable in the image. Image captions can further be used for searching and/or categorization processes associated with the image. For instance, the caption can be associated with the image, and used by a search engine in search indexing, etc.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of determining captions associated with an image. The method includes identifying, by one or more computing devices, first data associated with an image. The method further includes identifying, by the one or more computing devices, second data associated with the image. The method further includes determining, by the one or more computing devices, one or more image tags associated with the image based at least in part on the first data and the second data. The method further includes receiving, by the one or more computing devices, one or more user inputs. Each user input is indicative of a selection by the user of one of the one or more image tags. The method further includes determining, by the one or more computing devices, one or more caption templates associated with the image based at least in part on the first data and the second data. The method further includes generating, by the one or more computing devices, a caption associated with the image using at least one of the one or more caption templates. The caption is generated based at least in part on the one or more user inputs.

Other example aspects of the present disclosure are directed to systems, apparatus, tangible, non-transitory computer-readable media, user interfaces, memory devices, and electronic devices for determining image captions.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example user interface for determining image captions according to example embodiments of the present disclosure;

FIG. 2 depicts an example user interface for determining image captions according to example embodiments of the present disclosure;

FIG. 3 depicts an example user interface for determining image captions according to example embodiments of the present disclosure;

FIG. 4 depicts a flow diagram of an example method of determining image captions according to example embodiments of the present disclosure; and

FIG. 5 depicts an example system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to determining captions associated with an image. In particular, one or more image tags can be automatically determined based at least in part on metadata associated with an image and/or image recognition data associated with the image. For instance, the image recognition data can be determined using image recognition techniques. The image recognition data can include, for instance, image characteristics associated with the content depicted in the image. The image tags can be provided for display to a user, such that the user can select one or more of the image tags. Upon selection of one or more of the image tags, a caption can be generated using a caption template associated with the image. For instance, the caption can be generated by inserting at least one of the one or more selected image tags into a blank space associated with the caption template to form a sentence or phrase.

More particularly, metadata associated with an image can be identified or otherwise obtained. The image can be an image captured by an image capture device associated with a user, or other image. The metadata can include information associated with the image, such as location data (e.g. a location where the image was captured), a description of the content or context of the image (e.g. hashtags or other descriptors), temporal data (e.g. a timestamp), image properties, focus distance, user preferences, and/or other data. One or more image recognition and/or computer vision techniques can further be used on the image to determine image characteristics associated the content depicted in the image. In particular, the image recognition techniques can be used to identify information depicted in, or otherwise associated with, the image. For instance, the image recognition techniques can be used to determine one or more contextual categories associated with the image (e.g. whether the image depicts food, whether the image depicts an interior or exterior setting, etc.). The image recognition techniques can further be used to identify information such as the presence of people in the image, the presence and/or identity of particular items in the image, text depicted in the image, logos depicted in the image, and/or other information. In a particular embodiment, facial recognition techniques can be used to identify one or more persons depicted in the image.

One or more image tags can be determined from the metadata and/or the image recognition data. The image tags can include individual words or phrases associated with the image. The image tags can include broad descriptors, such as “food” or “drink,” and/or relatively narrower descriptors, such as “pizza” or “beer.” As another example, the image tags may include location descriptors such as the name of a restaurant or other location depicted in, or otherwise associated with, the image. For instance, if an image is captured at a sushi restaurant, a tag may specify a name or other descriptor associated with the sushi restaurant. It will be appreciated that various other suitable image tags may be determined describing various other aspects or characteristics of an image.

At least one of the image tags can be provided for display in association with the image. In this manner, the displayed tags can be selectable by a user, such that a user may select one or more of the image tags as desired. For instance, the image tags can be displayed in a user interface by a user device associated with the user. As used herein, a user device can include a smartphone, tablet, laptop computer, desktop computer, wearable computing device, or any other suitable computing device.

Upon a user selection of an image tag, one or more additional tags can be provided for display. The one or more additional tags can be determined based at least in part on the selected image tag. In particular, the additional image tags can include descriptors or other information associated with the selected image tag. For instance, if the selected image tag specifies “food,” the additional image tags may include information relating to food (e.g. “pizza,” “burgers,” etc.). In example embodiments, the additional image tags may be narrower in scope than the user selected image tag. The additional image tags may also be selectable as desired by the user.

In example embodiments, one or more image caption templates associated with the image may be determined or identified. A caption template may be a phrasal template having a sequence of words and one or more blank spaces in which words (e.g. image tags) can be inserted to complete a sentence or phrase. The caption template(s) can be determined, for instance, based at least in part on the metadata and the image recognition data associated with the image. For instance, a caption template can be associated with an activity or scene relating to the image. Different caption templates can be associated with different activities or scenes. For instance, if it is determined that an image depicts a restaurant, the determined caption template(s) can be directed towards activities such as eating or drinking at the restaurant. For instance, such a caption template may specify “Eating ______at ______,” wherein each “______” signifies a blank space wherein an image tag may be inserted.

Each blank space of a caption template can have an associated contextual category. The contextual categories may be indicative of one or more types of words that may be inserted into the blank space such that a sentence or phrase formed by inserting suitable words (e.g. words included in the contextual categories) into the blank space(s) is syntactically and contextually correct. In this manner, the contextual categories may include grammatical characteristics, such as parts of speech, tense, number (e.g. singular or plural), syntactic characteristics, etc. The contextual categories may further include contextual rules or guidelines to ensure that a sentence formed by inserting words into the blank space(s) makes sense contextually. For instance, the above example caption template begins with the word “eating,” and includes a blank space immediately thereafter. In this manner, the contextual category of the blank space may specify that a word inserted into the blank space be directed towards food or other items that can be eaten. Immediately thereafter, the caption template includes the word “at,” followed by another blank space. The contextual category for this blank space may include a location where food can be eaten.

Upon a user selection of one or more image tags and/or additional image tags, an image caption can be generated by selecting an image caption template and inserting at least one of the selected tag(s) into a suitable blank space of the selected caption template. For instance, a caption template can be selected based at least in part on the selected tag(s). In particular, the caption template can be selected such that when the selected tag(s) are inserted into the blank spaces of the caption template, an appropriate, syntactically correct sentence or phrase is formed. In this manner, the caption template can be determined such that the selected tag(s) are included in the contextual categories associated with the blank space(s) of the caption template. The caption can then be generated by inserting the selected tag(s) into the caption template.

In example embodiments, the determined image tags may include inferred tags and/or candidate tags. In this manner, the one or more tags may have associated confidence values. The confidence values may provide an indication of an estimated likelihood that the image tags accurately describe or relate to the content of or activities associated with image. In such embodiments, inferred tags may include image tags having an associated confidence value above a confidence threshold, and candidate tags may include image tags having an associated confidence value below the confidence threshold. In a particular implementation, a caption can be automatically generated for at least one inferred tag without the user having to select an image tag. In this manner, the candidate tags can be provided for display in association with the automatically generated caption and the inferred tag(s). The candidate tags may be selectable. For instance, when a user selects a candidate tag, a new caption may be generated based on the user selection, and in accordance with example embodiments of the present disclosure. In further example embodiments, the selected image tag(s) and/or an inferred image tag(s) can be removable by a user. In this manner, if a user removes a tag, a new caption may be generated based at least in part on the removal.

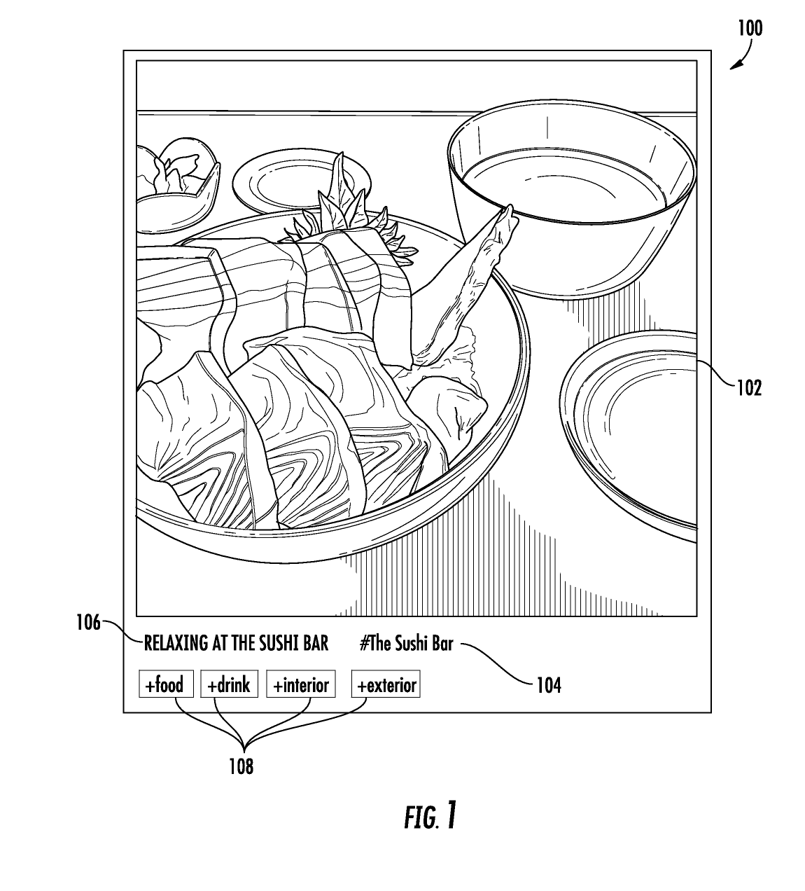

With reference now to the figures, example embodiments of the present disclosure will be discussed in further detail. For instance, FIGS. 1-3 depict an example user interface 100 associated with determining captions for an image. In particular, FIG. 1 depicts an image 102. Image 102 depicts a scene associated with a sushi meal at a restaurant. User interface 100 further includes an inferred image tag 104 (e.g. #The Sushi Bar) and an image caption 106 (e.g. Relaxing at The Sushi Bar). As indicated above, inferred image tag 104 and/or image caption 106 can be determined at least in part from metadata associated with image 102. Metadata can be information associated with an image that is not contained in the image itself. Inferred image tag 104 and/or image caption 106 can further be determined at least in part from image recognition data obtained using one or more image recognition and/or computer vision techniques. The image recognition and/or computer vision techniques can be used to identify one or more items or objects depicted in the image. For instance, such techniques can be used in association with image 102 to determine, for instance, that image 102 depicts a sushi bowl and a cup of soup being eaten at a restaurant. It will be appreciated that the image recognition and/or computer vision techniques can further be used to identify various other suitable aspects of an image, such as the presence and/or recognition of persons, logos, text, etc. depicted in an image, a time of day that the image was captured, whether the image was captured in an interior or exterior setting, and/or various other aspects of an image. In this manner, one or more image tags (e.g. inferred image tag 104) can be determined to relate to the metadata and/or image recognition data.

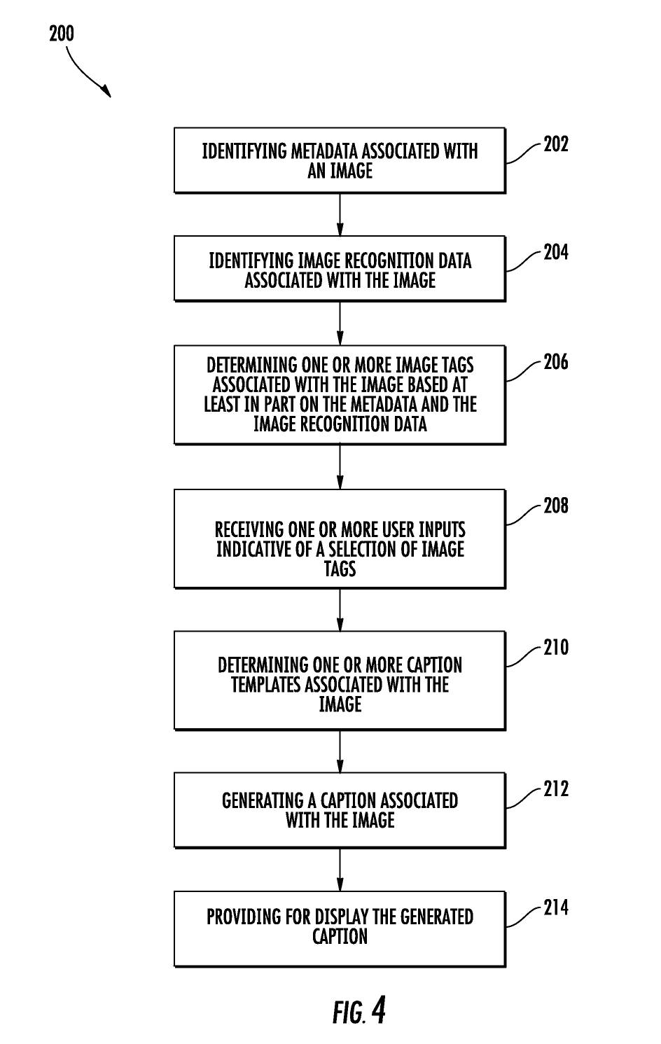

Image caption 106 can be generated based at least in part on inferred image tag 104. For instance, caption 106 can be generated by selecting an image caption template from a set of determined image caption templates, each image caption template including a sequence of words and blank spaces. As will be described in more detail below with regard to FIG. 4, an image caption template can be selected such that when inferred image tag 104 is inserted into the image caption template, a syntactically and contextually correct sentence or phrase is formed. For instance, caption 106 can be generated from a caption template that specifies “Relaxing at ______,” wherein the “______” signifies a blank space.

User interface 100 further includes candidate image tags 108. Candidate image tags 108 can further be determined at least in part from the metadata and/or image recognition data associated with the image. In this manner, candidate image tags 106 can further relate to depicted content and/or other information associated with image 102. Candidate image tags 106 can be selectable by a user. Similarly, inferred image tag 104 can be removable by the user. When a candidate image tag 106 is selected and/or inferred image tag 104 is removed by the user, one or more additional image tags may be determined, and a new image caption may be generated.

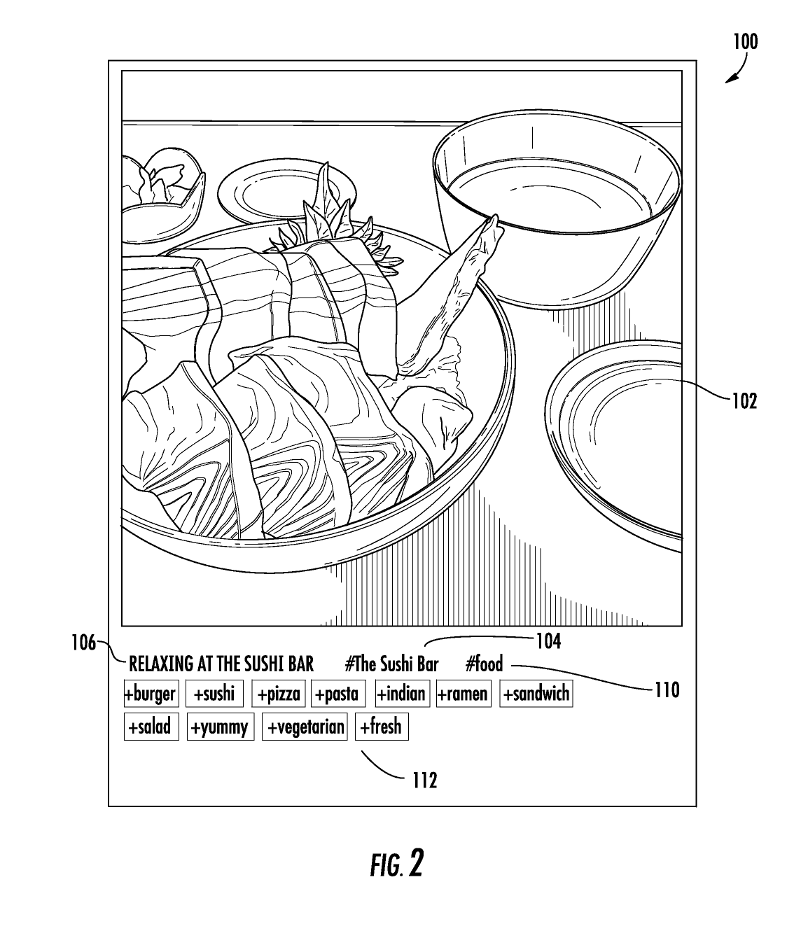

For instance, FIG. 2 depicts user interface 100 after a user has selected the candidate image tag 106 labeled “+food”. As depicted, the candidate image tag 106 labeled “+food” from FIG. 1 has become a selected image tag 110 labeled “#food.” In this manner, the selected image tags may be displayed and/or stored as hashtags. Further, additional candidate image tags 112 have been determined and provided for display in user interface 100. Additional candidate image tags 112 further relate to selected image tag 110 and inferred image tag 104. Selected image tag 110 can be removable by the user. For instance, if the user removes selected image tag 110, selected image tag 110 can again become a candidate image tag, and user interface 100 can display one or more different candidate image tags, such as those depicted in FIG. 1. In addition, similar to candidate image tags 106 depicted in FIG. 1, additional candidate image tags 112 can be selectable by the user. In this manner, when an additional candidate image tag 112 is selected, another set of candidate image tags can be determined and/or displayed and a new image caption can be generated.

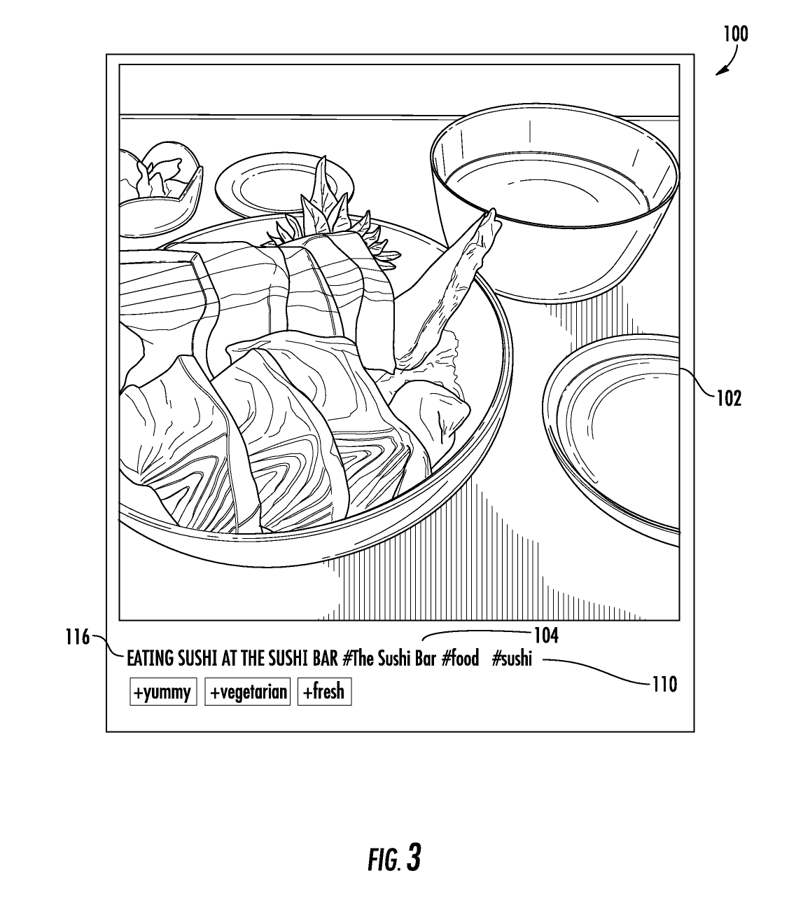

For instance, FIG. 3 depicts user interface 100 after the user has selected additional candidate image tag 112 labeled “+sushi.” As shown, “#sushi” is added as a selected image tag 110, and additional candidate image tags 114 are displayed. In addition, FIG. 3 depicts a new image caption 116 specifying “Eating sushi at The Sushi Bar.” For instance, new image caption 116 can be generated by selecting a new suitable image caption template and inserting inferred image tag 104 and the selected image tag 110 labeled “#sushi” into the caption template.

It will be appreciated that various other suitable image tags and/or image captions can be determined and/or generated. For instance, a user may select or remove various image tag combinations as desired until a sufficient image caption is generated. In addition, various other images depicting various other scenes or activities may include different metadata and/or image recognition data, and thereby may include different image tags, image caption templates and/or image captions without deviating from the scope of the present disclosure.

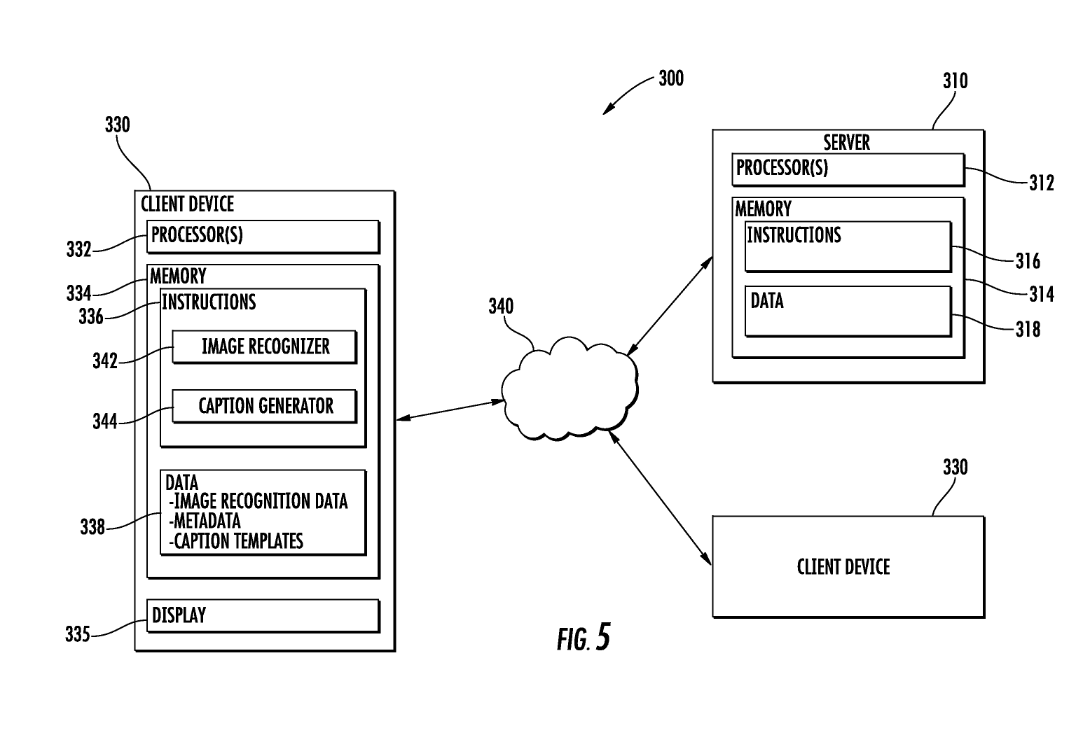

FIG. 4 depicts a flow diagram of an example method (200) of determining captions for an image according to example embodiments of the present disclosure. Method (200) can be implemented by one or more computing devices, such as one or more of the computing devices depicted in FIG. 5. In addition, FIG. 4 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (202), method (200) can include identifying metadata associated with an image. As indicated above, metadata may include information associated with an image and/or an image capture device that captured the image. For instance, metadata associated with the image may include ownership data, copyright information, image capture device identification data, exposure information, descriptive information (e.g. hashtags, keywords, etc.), location data (e.g. raw location data such as latitude, longitude coordinates, GPS data, etc.), and/or various other metadata.

At (204), method (200) can include identifying image recognition data associated with the image. As indicated above, the image recognition data can be obtained using one or more image recognition techniques to identify various aspects and/or characteristics of the content depicted in the image. For instance, the image recognition data may include one or more items, objects, persons, logos, etc. that are depicted in the image. In example embodiments, the image recognition data may be used to identify or determine one or more categories associated with the image, such as categories associated with the setting of the image, the contents depicted in the image, etc.

At (206), method (200) can include determining one or more image tags associated with the image based at least in part on the metadata and the image recognition data. As indicated above, the image tags can include descriptors (e.g. words or phrases) that are related to the content depicted in the image and/or various other aspects of the image. In example embodiments, the image tags may have associated confidence values providing an estimation of how closely the image tags relate to the image. In this manner, the image tags may be separated into inferred image tags and suggested image tags based at least in part on the confidence values of the image tags. In alternative embodiments, a user may input one or more tags associated with the image.

At (208), method (200) can include receiving one or more user inputs. Each user input may be indicative of a selection or removal by the user of an image tag. For instance, the image tags (and the image) may be displayed in a user interface on a user device. The user input may include one or more touch gestures, keystrokes, mouse clicks, voice commands, motion gestures, etc.

At (210), method (200) can include determining, or otherwise identifying, one or more caption templates associated with the image. The one or more caption templates may include a sequence of words and blank spaces, and may form at least a portion of a sentence or phrase. The caption template may be determined or identified based at least in part on the metadata and the image recognition data. In particular, the caption templates may relate to the content and/or other information associated with the image. For instance, if the image depicts a restaurant setting, the image caption templates may be directed to eating or enjoying food. In a particular implementation, the one or more captions may be determined based at least in part on the selected image tags. In this manner, caption templates may be determined or identified responsive to receiving metadata and/or image recognition data, or responsive to an inferred and/or a selected image tag.

At (212), method (200) can include generating a caption associated with the image. The caption can be generated by selecting an image caption template from the one or more determined caption templates. The image caption can be selected based at least in part on the selected image tag(s). For instance, the image caption template can be selected by identifying one or more contextual categories associated with the image caption templates and/or the blank spaces in the image caption templates, and selecting an image caption template having contextual categories that match or otherwise fit with the selected tag(s). In this manner, as described above, the contextual categories may include grammatical characteristics, such that the generated caption makes sense syntactically. The contextual categories may further include contextual characteristics such that the generated caption makes sense contextually.

At (214), method (200) can include providing for display the generated caption. For instance, the generated caption may be displayed in a user interface in association with the image.

In example embodiments, the image, the metadata, the image recognition data, the selected image tag(s), and/or the generated caption can be stored, for instance, in one or more databases at a server. For instance, the selected image tags may be stored as hashtags associated with the image. In this manner, such data can be associated with the image and can be used in searching, categorizing, and/or other processes associated with the image and/or similar images.

FIG. 5 depicts an example computing system 300 that can be used to implement the methods and systems according to example aspects of the present disclosure. The system 300 can be implemented using a client-server architecture that includes a server 310 that communicates with one or more client devices 330 over a network 340. The system 300 can be implemented using other suitable architectures, such as a single computing device.

The system includes one or more client devices, such as client device 330. The client device 330 can be implemented using any suitable computing device(s). For instance, each of the client devices 330 can be any suitable type of computing device, such as a general purpose computer, special purpose computer, laptop, desktop, mobile device, navigation system, smartphone, tablet, wearable computing device, a display with one or more processors, or other suitable computing device. A client device 330 can have one or more processors 332 and one or more memory devices 334. The client device 330 can also include a network interface used to communicate with one or more client devices 330 over the network 340. The network interface can include any suitable components for interfacing with one more networks, including for example, transmitters, receivers, ports, controllers, antennas, or other suitable components.

The one or more processors 332 can include any suitable processing device, such as a microprocessor, microcontroller, integrated circuit, logic device, or other suitable processing device. The one or more memory devices 334 can include one or more computer-readable media, including, but not limited to, non-transitory computer-readable media, RAM, ROM, hard drives, flash drives, or other memory devices. The one or more memory devices 314 can store information accessible by the one or more processors 332, including computer-readable instructions 316 that can be executed by the one or more processors 332. The instructions 336 can be any set of instructions that when executed by the one or more processors 332, cause the one or more processors 332 to perform operations. For instance, the instructions 336 can be executed by the one or more processors 332 to implement an image recognizer 342 configured to obtain information associated with an image using one or more image recognition techniques, and a caption generator 344 configured to generate image captions.

As shown in FIG. 5, the one or more memory devices 334 can also store data 338 that can be retrieved, manipulated, created, or stored by the one or more processors 332. The data 338 can include, for instance, image recognition data, metadata, caption templates, and other data. The data 338 can be stored in one or more databases. The one or more databases can be connected to the server 310 by a high bandwidth LAN or WAN, or can also be connected to server 310 through network 340. The one or more databases can be split up so that they are located in multiple locales.

The client device 330 can further include various input/output devices for providing and receiving information from a user, such as a touch screen, touch pad, data entry keys, image capture device, speakers, and/or a microphone suitable for voice recognition. For instance, the client device 330 can have a display device 335 for presenting a user interface displaying semantic place names according to example aspects of the present disclosure.

The client device 330 can also include a network interface used to communicate with one or more remote computing devices (e.g. server 310) over the network 340. The network interface can include any suitable components for interfacing with one more networks, including for example, transmitters, receivers, ports, controllers, antennas, or other suitable components.

The system 300 further includes a server 310, such as a web server. The server 310 can exchange data with one or more client devices 330 over the network 340. Although two client devices 330 are illustrated in FIG. 8, any number of client devices 330 can be connected to the server 310 over the network 340.

Similar to a client device 330, the server 310 can include one or more processor(s) 312 and a memory 314. The one or more processor(s) 312 can include one or more central processing units (CPUs), and/or other processing devices. The memory 314 can include one or more computer-readable media and can store information accessible by the one or more processors 312, including instructions 316 that can be executed by the one or more processors 312 and data 318.

The network 340 can be any type of communications network, such as a local area network (e.g. intranet), wide area network (e.g. Internet), cellular network, or some combination thereof. The network 340 can also include a direct connection between a client device 330 and the server 310. In general, communication between the server 310 and a client device 330 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of determining captions associated with an image, the method comprising:
identifying, by one or more computing devices, metadata associated with an image;
identifying, by the one or more computing devices, image characteristic data associated with the image;
determining, by the one or more computing devices, one or more image tags associated with the image based at least in part on the metadata and the image characteristic data;
receiving, by the one or more computing devices, one or more user inputs, each user input being indicative of a selection by the user of one of the one or more image tags;
determining, by the one or more computing devices, one or more caption templates associated with the image based at least in part on the metadata and the image characteristic data; and
generating, by the one or more computing devices, a caption associated with the image using at least one of the one or more caption templates, the caption being generated based at least in part on the one or more user inputs.

2. The computer-implemented method of claim 1, wherein the caption template comprises a phrasal template having a sequence of words and one or more blank spaces in which words can be inserted.

3. The computer-implemented method of claim 2, wherein generating, by the one or more computing devices, a caption associated with the image comprises:
selecting, by the one or more computing devices, a caption template from the one or more caption templates based at least in part on the one or more user inputs;
identifying, by the one or more computing devices, a contextual category associated with each of the one or more blank spaces in the caption template; and
inserting, by the one or more computing devices, an image tag into each blank space in the caption template based at least in part on the identified contextual categories and the one or more user inputs.

4. The computer-implemented method of claim 1, further comprising providing for display, by the one or more computing devices, the generated caption in a user interface associated with the image.

5. The computer-implemented method of claim 1, wherein the image characteristic data comprises data related to one or more image characteristics associated with content depicted in the image.

6. The computer-implemented method of claim 6, wherein the image characteristic data is obtained using one or more image recognition techniques.

7. The computer-implemented method of claim 1, further comprising, responsive to receiving the one or more user inputs, determining, by the one or more computing devices, one or more second tags associated with the image based at least in part on the one or more user inputs.

8. The computer-implemented method of claim 8, wherein the one or more second tags are further determined based at least in part on the metadata and the image characteristic data.

9. The computer-implemented method of claim 1, wherein the one or more image tags comprise at least one inferred image tag and at least one candidate image tag.

10. The computer-implemented method of claim 10, further comprising, prior to receiving the one or more user inputs, generating, by the one or more computing devices, a caption associated with the image based at least in part on the at least one inferred image tag.

11. The computer-implemented method of claim 10, wherein the at least one inferred image tag and the at least one candidate image tag are determined based at least on a confidence value associated with the one or more image tags.
